(19) United States
(12) Patent Application Publication
(10) Pub. No.: US 2004/0116322 A1
(43) Pub. Date: Jun. 17, 2004

(54) Concentrated fabric softener compositions containing rheology modifiers to maintain stability and flowability upon dilution

(75) Inventors: Georges Yianakopoulos, Liege (BE); Patricia Pagnoul, Amay (BE); Isabelle Salesses, Liege (BE); Ericka Breuer, Grace Hollogne (BE)

Correspondence Address: Patent Department, Colgate-Palmolive Company, 909 River Road, P.O. Box 1343, Piscataway, NJ, 08855-1343, US

(73) Assignee: Colgate-Palmolive Company

(21) Appl. No.: 10/424,441

(22) Filed: Apr. 28, 2003

Related U.S. Application Data
(63) Continuation-in-part of application No. 10/320,067, filed on Dec. 16, 2002.

(51) Int. Cl. C11D 3/00

(52) U.S. Cl. 510/515

(57) ABSTRACT

A stable concentrated aqueous fabric softening composition is provided having a viscosity of from about 3000 cps to about 15,000 cps, preferably 4000 to 15000 cps, which composition is capable of being diluted with water in a 4:1 weight ratio of water to concentrated softening composition prior to use such that the resulting diluted softening composition is physically stable and has a medium viscosity of from about 90 cps to about 300 cps, said composition comprising:

a) from about 5% to about 30%, by weight, of a cationic fabric softener;

b) at least about 0.01%, by weight, of (i) a cationic linear homopolymer derivable from the polymerization of acrylic acid and/or methacrylic acid; or (ii) a linear copolymer as defined each having a molecular weight of from about 10,000 to about 30 million; or (iii) a cationic cross-linked polymer that is derivable from the polymerization of, from 5 to 100 mole percent of cationic vinyl addition monomer, from 0 to 95 mole percent of acrylamide, and from 70 ppm to 300 ppm of a difunctional vinyl addition monomer cross-linking agent; or

c) at least about 0.01%, by weight of a mixture of polymers comprising a cationic linear homopolymer or linear copolymer as defined in (i) or (ii) herein, respectively, and a cationic cross-linked polymer as defined in (iii) herein, the respective amounts of (i) or (ii) or (iii) in said concentrated softening composition being selected to provide the desired medium viscosity of from about 90 cps to about 300 cps in said diluted composition; and

d) balance water

This application is a continuation-in-part of copending application Ser. No. 10/320,067 filed Dec. 16, 2002, the disclosure of which is incorporated herein by reference.

### TECHNICAL FIELD OF THE INVENTION

The present invention relates to concentrated fabric conditioning compositions, and more particularly to aqueous rinse-cycle concentrated fabric softener compositions containing a cationic polymer or mixture of cationic polymers, which concentrated composition is capable of being diluted with water prior to use in a 4:1 weight ratio of water to concentrate to provide a physically stable softener composition in both the concentrated and diluted form, and wherein the concentrated and diluted compositions are physically stable and manifest commercially desirable levels of viscosity.

### BACKGROUND OF THE INVENTION

Conventionally, most liquid fabric conditioning or fabric softener compositions make use of the thickening properties of surfactant ingredients or added salts to provide a desired rheology. More recently, the trend has been to incorporate specific thickeners into fabric softening compositions to provide a desired viscosity which remains stable over extended periods of time.

In commercial liquid fabric softener formulations the rheological properties of the product are critical for consumer acceptance. A common method of enhancing product appeal and conveying a perception of product richness and efficacy is to increase the apparent viscosity of the liquid product to a value of at least above 50 cps (as measured on a Brookfield RVT, 50 rpm, Spindle 2). Cationic linear or cross-linked polymers are well-known in the art as ingredients to provide apparent viscosity in fabric softener compositions.

Another common technique for enhancing product appeal is to modify the flow elasticity components of the liquid product so as to reduce the flow thereby rendering it more syrupy in nature while avoiding an aesthetically unpleasing stringy and non-uniform flow. However, there is no known method to modify the flow elasticity properties at a given level of viscosity insofar as flow elasticity is a function of the cationic polymer structure itself, and its level in the product composition.

Linear cationic polymers having high molecular weights are known to provide high flow elasticity to liquid fabric softeners. But, the resulting compositions are often sensitive to inorganic electrolytes and high shear resulting in liquid products which are generally unstable and separate into different phases upon aging.

The formulation of a concentrated fabric softening composition which can be diluted by the consumer prior to use and introduced into the rinse cycle in diluted form presents a particularly difficult challenge. This is because it is commercially imperative that such concentrate be a physically stable and appropriately flowable softening composition in both the concentrated and diluted forms, i.e. both prior to and after dilution of the concentrate by the consumer. Where the desired degree of dilution is on the order of 4:1 (weight ratio of water to concentrated composition) it is difficult to provide a softening composition which is capable of maintaining its physical stability and still provide a consumer acceptable flow viscosity in both the concentrated and diluted compositions.

In EP 394 133 (Colgate-Palmolive) there are described stable aqueous fabric softening compositions containing a di-long chain, di-short chain quaternary ammonium softening compound in combination with a fatty alcohol and a water-soluble polymer to improve the rheological properties and enhance the softening performance of the composition.

WO 90/12862 (BP Chemicals Ltd.) discloses aqueous based fabric conditioning formulations comprising a water dispersible cationic softener and as a thickener a cross-linked cationic polymer that is derivable from a water soluble cationic ethylenically unsaturated monomer or blend of monomers, which is cross-linked by 5 to 45 ppm of a cross-linking agent comprising polyethylenic functions. An example of such a cross-linking agent is methylene bis acrylamide.

In EP-A-0 799 887 (Procter & Gamble) liquid fabric softening compositions are described which are said to exhibit an excellent viscosity and phase stability as well as softness performance, which compositions comprise: (a) 0.01-10 wt. % of a fabric softener component, (b) at least 0.001% of a thickening agent selected from the group of (i) associative polymers having a hydrophilic backbone and at least two hydrophobic groups per molecule attached to the hydrophilic backbone, (ii) the cross-linked cationic polymers described in the above-mentioned WO 90/12862, cross-linked by 5-45 ppm of cross-linking agent comprising polyethylenic functions and (iii) mixtures of (i) and (ii), and (c) a component capable of sequestering metal ions.

In WO 02/057400 (Colgate-Palmolive) fabric conditioning compositions are described containing cationic polymeric thickeners obtained by polymerizing a water soluble cationic vinyl addition monomer, from 0 to 95 mole percent of acrylamide and from 70 to 300 ppm of difunctional vinyl addition monomer cross-linking agent. The thickened softening compositions are stated to be especially efficient for delivering fragrance in the softening composition to the treated fabrics.

While the use of polymeric thickeners to enhance consumer appeal is widely known in the prior art, there remains a need for concentrated liquid fabric softeners which are physically stable and flowable at an elevated viscosity, and which can be diluted with water on the order of 4:1 for use in the rinse cycle while remaining physically stable and readily pourable as a diluted composition in the range of a medium viscosity liquid.

### SUMMARY OF THE INVENTION

The present invention provides a stable concentrated aqueous fabric softening composition having a viscosity of from about 3000 cps to about 15,000 cps, preferably 4000 to 15000 cps, which composition is capable of being diluted with water in a 4:1 weight ratio of water to concentrated softening composition prior to use such that the resulting diluted softening composition is physically stable and has a medium viscosity of from about 90 cps to about 300 cps, said composition comprising:

a) from about 5% to about 30%, by weight, of a cationic fabric softener;

b) at least about 0.01%, by weight, of (i) a cationic linear homopolymer that is derivable from the polymerization of acrylic acid and/or methacrylic acid; or (ii) a linear copolymer that is derivable from the polymerization of acrylic acid and/or methacrylic acid and acrylamide or methacrylamide, said homopolymer or copolymer having a molecular weight of from about 10,000 to about 30 million; or (iii) a cationic cross-linked polymer that is derivable from the polymerization of, from 5 to 100 mole percent of cationic vinyl addition monomer, from 0 to 95 mole percent of acrylamide, and from 70 ppm to 300 ppm of a difunctional vinyl addition monomer cross-linking agent; or

c) at least about 0.01%, by weight of a mixture of polymers comprising a cationic linear homopolymer or linear copolymer as defined in (i) or (ii) herein, respectively, and a cationic cross-linked polymer as defined in (iii) herein, the respective amounts of (i) or (ii) or (iii) in said concentrated softening composition being selected to provide the desired medium viscosity of from about 90 cps to about 300 cps in said diluted composition.

The present invention is predicated on the discovery that the use of a cationic homopolymer or copolymer or cross-linked polymer, or a mixture of such cationic polymers as defined herein in an aqueous concentrated rinse-cycle fabric softening composition allows the rheological properties of flow elasticity and viscosity to be regulated so as to achieve the desired flow properties of thickness and ease of pourability at a viscosity of from 4,000 to 15,000 cps in the concentrated composition and a medium viscosity of from 90 cps to 300 cps in the diluted composition. Accordingly, flow elasticity can be readily controlled and regulated according to the present invention independently of the regulation of the Brookfield viscosity.

The liquid viscosity as that term is used herein is expressed in centipoise as measured on a Brookfield RVT at 50 rpm with Spindle 2.

The term “flow elasticity” or “flow elasticity index” refers to the primary normal stress difference in units of Pascal as defined in “Viscoelastic Properties of Polymers”, John D. Ferry, 3rd Edition, John Wiley & Sons, Inc., Chapter 1, which is measured at a shear rate of 2500S⁻¹.

In practice, when a liquid fabric softener is poured, a high flow elasticity reduces the flow thereby making the flow appear more syrupy, which is often perceived as a signal of richness by consumers. The higher the flow elasticity, the slower the flow. If the flow elasticity becomes too high, the flow of the fabric softener becomes stringy and tacky leading to messiness when dispensing the liquid product into the washing machine. This is obviously an unwanted condition from a commercial standpoint.

For a given chemistry, the only way to modify the elasticity flow as defined herein is to either modify the molecular weight of the polymer, its degree of cross-linking or its concentration.

In the case of a linear polymer, in order to build acceptable Brookfield viscosity without using a large amount of polymer, the molecular weight of the polymer must be high which induces high flow elasticity. It is possible to reduce the flow elasticity using a low molecular weight polymer but to reach the same Brookfield viscosity, the level of polymer in the composition has to be increased. This not only implies a higher cost but also introduces a stability problem in the emulsion due to the high ionic strength.

In contrast thereto, the combination of linear and cross-linked polymer in accordance with the invention is able to provide a desirable viscosity and flow elasticity while using a moderate amount of polymer and at the same time avoiding problems of product stability.

In a preferred embodiment the linear polymer used in the polymeric mixture of the invention is an homopolymer of quaternary ammonium acrylate having a molecular weight of about 8 million which polymer is sold as Floerger EM 949 CT by SNF Floerger of France (Ethanaminium N,N,N-trimethyl-2-((1-oxo-2-propenyl)oxy-)-,chloride homopolymer); and the same structural polymer having a molecular weight of about 5 million is sold as Floerger EM 949 L by the same manufacturer.

In another preferred embodiment the cross-linked polymer used in the polymeric mixture of the invention is a cross-linked copolymer of acrylamide and methacrylate with 150 ppm of methylene bisacrylamide, and a molecular weight of below 5 million prior to the cross-linking; the polymer is sold as Flosoft DP 200 by SNF Floerger of France.

The present invention also encompasses a method for softening fabrics comprising rinsing the fabrics to be treated in an aqueous bath containing an effective amount of the above-defined fabric softening composition.

A preferred cationic softener is an esterquat compound having the following structural formula:

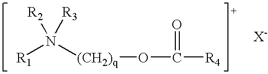

wherein R4 represents an aliphatic hydrocarbon group having from 8 to 22 carbon atoms, R₂ and R₃ represent (CH₂)ₛ-R₅ where R₅ represents an alkoxy carbonyl group containing from 8 to 22 carbon atoms, benzyl, phenyl, (C1—C4)-alkyl substituted phenyl, OH or H; R1 represents (CH₂)ₜ R₆ where R₆ represents benzyl, phenyl, (C1—C4)-alkyl substituted phenyl, OH or H; q, s, and t, each independently, represent an integer from 1 to 3; and X⁻ is a softener compatible anion.

A particularly preferred cationic softener is a fatty ester quaternary ammonium compound derived from the reaction of an alkanol amine and a fatty acid derivative followed by quaternization, said fatty ester quaternary ammonium compound being represented by the formula:

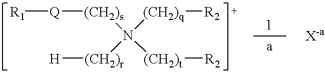

wherein Q represents a carboxyl group having the structure —OCO—or —COO—; R1 represents an aliphatic hydrocarbon group having from 8 to 22 carbon atoms; R2 represents —Q—R1 or —OH; q, r, s and t, each independently represent a number of from 1 to 3; and X^{-a} is an anion of valence a; and

wherein said fatty ester quaternary ammonium compound is comprised of a distribution of monoester, diester and triester compounds, the monoesterquat compound being formed when each R₂ is —OH; the diesterquat compound being formed when one R₂ is —OH and the other R₂ is —Q—R1; and the triesterquat compound being formed when each R₂ is —Q—R1; and wherein the normalized percentage of monoesterquat compound in said fatty ester quaternary ammonium compound is from about 28% to about 39%; the normalized percentage of diesterquat compound is from about 52% to about 62% and the normalized percentage of triesterquat compound is from about 7% to about 14%; all percentages being by weight.

The percentages, by weight, of mono, di, and tri esterquats, as described above are determined by the quantitative analytical method described in the publication “Characterisation of quaternized triethanolamine esters (esterquats) by HPLC HRCGC and NMR” A. J. Wilkes, C. Jacobs, G. Walraven and J. M. Talbot—Colgate Palmolive R&D Inc.—4th world Surfactants Congress, Barcelone, 3-7 VI 1996, page 382. The percentages, by weight, of the mono, di and tri esterquats measured on dried samples are normalized on the basis of 100%. The normalization is required due to the presence of about 10% to 15%, by weight, of non-quaternized species, such as ester amines and free fatty acids. Accordingly, the normalized weight percentages refer to the pure esterquat component of the raw material.

### DETAILED DESCRIPTION OF THE INVENTION

The cross-linked copolymer used in the compositions of the present invention is a cross-linked cationic vinyl polymer which is cross-linked using a cross-linking agent of a difunctional vinyl addition monomer at a level of from 70 to 300 ppm, preferably from about 75 to 200 ppm, and most preferably of from about 80 to 150 ppm. These polymers are further described in U.S. Pat. No. 4,806,345 and the above-mentioned WO 02/057400, which documents are incorporated herein by reference.

Generally, such polymers are prepared as water-in-oil emulsions, wherein the cross-linked polymers are dispersed in mineral oil, which may contain surfactants. During finished product making, in contact with the water phase, the emulsion inverts, allowing the water soluble polymer to swell.

The most preferred thickener for use in the present invention is a cross-linked copolymer of a quaternary ammonium acrylate or methacrylate in combination with an acrylamide comonomer.

The linear polymer used in the compositions of the present invention is a water soluble linear cationic homopolymer of acrylate or methacrylate with a molecular weight of between 10,000 and 30 million, most preferably between 5 and 8 million.

Such polymers are usually prepared as a water in oil emulsions which may contain surfactants but are also supplied in powdered form.

Preferred polymer for use in the present invention is a linear homopolymer of quaternary ammonium acrylate with a molecular weight of 5 Million.

If necessary, the compositions of the invention may contain an emulsifier to disperse the softening ingredient(s) in the composition and to insure the physical stability of the composition. Optionally, an emulsifier may be included in the softener composition, such as, a fatty alcohol ethoxylate having an alkyl chain length from about 13 to 15 carbon atoms and wherein the number of ethylene groups is from about 15 to 20 per mole. Especially preferred for such use is Synperonic A20 manufactured by ICI Chemicals, a nonionic surfactant which is an ethoxylated C₁₃—C₁₅ fatty alcohol with 20 moles of ethylene oxide per mole of alcohol.

The compositions of the invention may contain from 0% to about 5% of a perfume. As used herein, the term “perfume” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced odoriferous substances. Typically, perfumes are complex mixtures of blends of various organic compounds such as alcohols, aldehydes, ethers, aromatic compounds and varying amounts of essential oils (e.g., terpenes), the essential oils themselves being volatile odoriferous compounds and also serving to dissolve the other components of the perfume.

In the present invention, the particular composition of the perfume is of no importance with regard to the performance of the liquid fabric softener composition so long as it meets the criteria of water immiscibility and having a pleasing odor.

The compositions of the invention may contain from 0% to about 2% of a preservative agent such as solutions of lactic acid or formaldehyde or dispersion of 1,2-dibromo-2,4-dicyanobutane mixed with bromonitro propanediol (Euxyl K446 from Schulke & Mayr) or dispersion of 1.2-benzisothiazolin-3-one molecule (Proxel BD2 or GXL from Avecia Biocides).

A co-softener may optionally be included in the present composition such as, for example, fatty alcohol, glycerol mono-stearate or glycerol mono-oleate.

Other optional components commonly used in fabric softening compositions may be added in minor amounts to enhance either the appearance or performance properties of the liquid fabric softener compositions of this invention. Typical components of this type include, but are not limited to colorants, e.g., dyes or pigments, bluing agents and germicides, opacifying agents.

The fabric softener composition, whether in concentrated or diluted form must be easily pourable by the end user. Generally, therefore, product viscosity when used by the consumers should not exceed about 15000 centipoises for products intended for dilution. The viscosity is measured at 25° C. (22° C.-26° C.) using a Brookfield RVTD Digital viscometer with Spindle #3 at 10 rpm.

A sequestering or chelating compound may optionally be included in the fabric softening compositions of the invention at a concentration of from 0% to 2%, by weight. The useful sequestering compounds are capable of sequestering metal ions and are present at a level of at least 0.001%, by weight, of the softening composition, preferably from about 0.001% (10 ppm) to 0.5%, and more preferably from about 0.005% to 0.25%, by weight. The sequestering compounds which are acidic in nature may be present either in the acidic form or as a complex/salt with a suitable counter cation such as an alkali or alkaline earth metal ion, ammonium or substituted ammonium ion or any mixtures thereof.

The sequestering compounds are selected from among amino carboxylic acid compounds and organo aminophosphonic acid compounds, and mixtures of same. Suitable amino carboxylic acid compounds include: ethylenediamine tetraacetic acid (EDTA); N-hydroxyethylenediamine triacetic acid; nitrilotriacetic acid (NTA); and diethylenetriamine pentaacetic acid (DEPTA).

Suitable organo aminophosphonic acid compounds include: ethylenediamine tetrakis (methylenephosphonic acid); 1-hydroxyethane 1,1-diphosphonic acid (HEDP); and aminotri (methylenephosphonic acid).

### EXAMPLES

In the following Examples the linear homopolymers, linear copolymers and cationic cross-linked polymers are described below with reference to their commercial name:

Flosoft DP200 (ex SNF)—a cationic cross-linked copolymer of a quaternary ammonium acrylate or methacrylate in combination with an acrylamide comonomer having a molecular weight of below about 5 million, preferably 4 million.

Floerger 949 CT (ex SNF)—a water soluble linear homopolymer of acrylate or methacrylate with a molecular weight of about 8 million.

Floerger EM 949L (ex SNF)—water soluble linear homopolymer of acrylate or methacrylate with molecular weight of about 5 million.

Floerger DP/LC 2322A (ex SNF)—Cationic cross-linked copolymer of a quaternary ammonium acrylate or methacrylate in combination with an acrylamide comonomer using a cross-linking agent of a difunctional vinyl addition monomer (MBA, i.e. Methylene Bisacrylamide) at a level from 70-300 ppm, preferably from about 75 to 200 ppm, and most preferably of from 80 to 150 ppm. This copolymer is similar to Flosoft DP 200, except it contains more transfer agent (450-600 ppm) than the Flosoft DP200, which contains about 300-400 ppm. The resulting Floerger DP/LC 2322A is a more branched and water swelling polymer than the Flosoft DP200 characterized by an intrinsic viscosity <4 dl/g prior to cross-linking.

Floerger DP/LC 2322B (ex SNF)—Cationic cross-linked copolymer of a quaternary ammonium acrylate or methacrylate in combination with an acrylamide comonomer using a cross-linking agent of a difunctional vinyl addition monomer (MBA) at a level from 70-300 ppm, preferably from about 75 to 200 ppm, and most preferably of from 80 to 150 ppm. This copolymer is similar to Flosoft DP 200, except it contains more transfer agent (600-800 ppm) than the Flosoft DP200, which contains 300-400 ppm. The resulting Floerger DP/LC 2322B is a more branched and water swelling polymer than the Flosoft DP200 characterized by an intrinsic viscosity <4 dl/g prior to cross-linking.

Typical concentrated fabric softening compositions of the invention intended for 4:1 dilution are shown below in Examples 1-7 containing as the cationic softener Esterquat B (Tradename L1-90; ex KAO) which is characterized by a distribution of about 34% monoester, about 56% diester, and about 10% triester compounds (normalized percent by weight). The viscosity of the concentrated (neat) product and the viscosity after 4:1 dilution are shown in the Examples.

| A.I.s (%) | Example 1 | Example 2 | Example 3 | Example 4 | Example 5 | Example 6 | Example 7 |
|---|---|---|---|---|---|---|---|
| Esterquat | 15 wt % | 15 wt % | 15 wt % | 15 wt % | 15 wt % | 15 wt % | 5.3 wt % |
| Perfume | 1.2 | 1.16 | 1.16 | 1.16 | 1.16 | 1.16 | 0.8 |
| Dye | 0.0067 | 0.0067 | 0.0067 | 0.0067 | 0.0067 | 0.0067 | |
| Preservative (Formaldehyde) | 0.8 | 0.8 | 0.8 | 0.8 | 0.8 | 0.8 | 0.8 |
| Sequestering Agent | 0.1 | 0.1 | 0.1 | 0.1 | 0.1 | 0.1 | 0.1 |
| Polymer:Flosoft DP200 | 0.56 | | | 0.5 | | | 0.8 |
| Polymer:Floerger EM949CT | | 0.53 | | | | | |
| Polymer:Floerger EM949L | | | 0.7 | 0.18 | | | |
| Polymer:Floerger DP/LC | | | | | 0.56 | | |
| 2322A | | | | | | | |
| Polymer:Floerger DP/LC | | | | | | 0.7 | |
| 2322B | | | | | | | |
| Water | Balance | Balance | Balance | Balance | Balance | Balance | Balance |
| Viscosity of neat product | 8820 | 6570 | 7230 | 8110 | 9200 | 8700 | 4710 |
| Viscosity after 4X | 98 | 170 | 114 | 122 | 95 | 120 | 178 |
| dilution:120 ppm water | | | | | | | |
| hardness | | | | | | | |

Concentrated softener compositions outside of the invention are shown below in Examples 8-11 which contain commercial thickeners outside of the present claims.

| A.I.s (%) | Example 8 | Example 9 | Example 10 | Example 11 |
|---|---|---|---|---|
| Esterquat | 18 wt % | 15 wt % | 15 wt % | 18 wt % |
| Perfume | 1.6 | 1.16 | 1.16 | 1.6 |
| Dye | 0.0067 | 0.0067 | 0.0067 | 0.0067 |
| Preservative | 0.8 | 0.8 | 0.8 | 0.8 |
| Sequestering Agent | 0.1 | 0.1 | 0.1 | 0.1 |
| Associative thickener:Fatty | | | | 1.8 |
| alcohol ethoxylate- | | | | |
| diruethane (ex BASF) | | | | |
| ¹Natrosol HHBR 250 | 1 | | | |
| ²EHEC ELFACOS CD 481 | | 0.56 | | 0.18 |
| ³EHEC + fatty chain | | | 0.56 | |
| ELFACOS CD HM | | | | |
| Water | Balance | Balance | Balance | Balance |
| Viscosity of neat product | 17500 | 26400 | 26500 | 18000 |
| Viscosity after 4X | 70 | 41 cps and | 47 cps and | 20 |
| dilution: 120 ppm water | | dephased | dephased | |
| hardness | | after 1 day | after 1 day | |

¹Natrosol HHBR250: Hydroxyethyl cellulose
²EHEC ELFACOS CD 481: Hydroxyethyl ethylcellulose
³EHEC ELFACOS CDHM: Hydroxyethyl ethylcellulose containing C12-C16 fatty chains.

Examples 1 to 7 demonstrate that the use of a cationic copolymer or homopolymer or mixture of copolymer-homopolymer in accordance with the invention provides stable concentrated compositions capable of being diluted with water prior to use in a 4:1 weight ratio of water to concentrated softener composition, and wherein the concentrated and diluted compositions are physically stable and manifest commercially desirable levels of viscosity (>90 cps in the diluted form and from 3,000 to 15,000 cps in the concentrated form).

Examples 8 to 11 demonstrate that the use of other types of well known thickeners which are outside of the present invention, such as associative or cellulose based thickeners, provides very thick and viscous concentrated compositions which once diluted prior to use in a 4:1 weight ratio of water to concentrate are not physically stable. The concentrated as well as the diluted products manifest commercially undesirable levels of viscosity.

What is claimed is:

1. A stable concentrated aqueous fabric softening composition-having a viscosity of from about 3000 cps to about 15,000 cps, which composition is capable of being diluted with water in a 4:1 weight ratio of water to concentrated softening composition prior to use such that the resulting diluted softening composition is physically stable and has a medium viscosity of from about 90 cps to about 300 cps, said composition comprising:
a) from about 5% to about 30%, by weight, of a cationic fabric softener;
b) at least about 0.01%, by weight, of (i) a cationic linear homopolymer that is derivable from the polymerization of acrylic acid and/or methacrylic acid; or (ii) a linear copolymer that is derivable from the polymerization of acrylic acid and/or methacrylic acid and acrylamide or methacrylamide, said homopolymer or copolymer having a molecular weight of from about 10,000 to about 30 million; or (iii) a cationic cross-linked polymer that is derivable from the polymerization of, from 5 to 100 mole percent of cationic vinyl addition monomer, from 0 to 95 mole percent of acrylamide, and from 70 ppm to 300 ppm of a difunctional vinyl addition monomer cross-linking agent; or
c) at least about 0.01%, by weight of a mixture of polymers comprising a cationic linear homopolymer or linear copolymer as defined in (i) or (ii) herein, respectively, and a cationic cross-linked polymer as defined in (iii) herein, the respective amounts of (i) or (ii) or (iii) in said concentrated softening composition being selected to provide the desired medium viscosity of from about 90 cps to about 300 cps in said diluted composition.
d) from 0% to about 10% by weight of a sequestering compound selected from the group consisting of amino-carboxilic acid compounds, organo aminophosphonic acid compounds and mixtures of thereof;
e) from 0% to about 5% by weight of a perfume;
f) from 0% to about 10% by weight of an emulsifier;
g) from 0 to about 10% by weight of one or more adjuvants selected from the group consisting of dyes, opacifying agent, build agents and preservatives; and
h) balance water

2. A fabric softening composition in accordance with claim 1, which further contains from 0% to about 10% by weight of a co-softener selected from the group consisting of fatty alcohol, glycerol monostearate and glycerol monooleate.

3. A fabric softener composition in accordance with claim 1 wherein said emulsifier is a fatty alcohol ethoxylate nonionic surfactant.

4. A fabric softening composition of claim 1 where said cationic linear polymer comprises a quaternary salt of acrylate or methacrylate.

5. A fabric softening composition of claim 1 where said cationic cross-linked polymer is a cross-linked vinyl polymer.

6. A fabric softening composition of claim 1 where said cationic cross-linked polymer comprises a quaternary salt of acrylate or methacrylate.

7. A fabric composition of claim 1 wherein said cationic softener is selected from the group consisting of quaternary ammonium compounds, esterquats, imidazolinium quats and difatty diamide ammonium methyl sulfate.

8. A fabric softening composition of claim 7 wherein said cationic softener comprises ditallow diester ammonium methosulfate.

9. A fabric softening composition of claim 7 wherein said cationic softener comprises an esterquat.

10. A method for softening fabrics comprising forming an aqueous solution containing an effective amount of the fabric softening composition of claim 1 and then contacting the fabrics to be softened with said aqueous solution.
